(19) United States
(12) Patent Application Publication
(10) Pub. No.: US 2002/0077993 A1
(43) Pub. Date: Jun. 20, 2002

(54) Method and system for conducting wireless payments

(75) Inventors: Olli Immonen, Helsinki (FI); Mia Lahteenmaki, Helsinki (FI)

Correspondence Address: Clarence A. Green, PERMAN & GREEN, LLP, 425 Post Road, Fairfield, CT, 06430, US

(73) Assignee: Nokia Corporation

(21) Appl. No.: 09/740,309

(22) Filed: Dec. 18, 2000

(51) Int. Cl. G06F 17/60; H04K 1/00; H04L 9/00

(52) U.S. Cl. 705/77; 705/64; 705/78; 705/26

(57) ABSTRACT

A method and system for conducting payments with a wireless terminal by a user in exchange for goods and services rendered by a merchant. In an embodiment of the invention, a Wireless Application Protocol (WAP) server for use with a WAP compliant terminal enables the user to browse merchants from a portal page over an HTTP connection. The user selects items for purchase in which payment to the merchant is initiated using the Secure Electronic Transaction (SET) protocol to a Server Wallet server. In one aspect of the invention, the user provides proof of identity and confirmation for the payment with a digital signature calculated by a Wireless Identity Module (WIM) operating with the wireless terminal. The Server Wallet, which retains sensitive financial information such as a payment card accounts e.g. credit cards numbers, carries out the payment transaction to the merchant on behalf of the user. The result of the transaction is returned to the user via standard secure WAP protocols.

### FIELD OF INVENTION

The present invention relates generally to electronic commerce and, more particularly, to a method and system for conducting payments using wireless terminals.

### BACKGROUND OF THE INVENTION

The Internet and that portion of the Internet comprising the World Wide Web (WWW or Web) has proven to be a useful and effective way for people to access vast amounts of information quickly and conveniently. Accordingly, Internet content and the number of services provided thereon have increased dramatically and is projected to continue to do so for many years. As the Internet becomes increasingly prevalent throughout the world, more and more people are coming to rely on the medium as a necessary part of their daily lives. The Internet has been a leading driver behind the expansion of electronic commerce (e-commerce) that allows customers to conduct business with a vast number of merchants easily and conveniently.

Another industry that is experiencing rapid growth is in the area of mobile telephony. The number of mobile users is expected to grow substantially and, by many estimates will, if not already, outnumber the computer based users of the traditional Internet. The large numbers of current and projected mobile subscribers has created a desire to bring the benefits of the Internet to the mobile world. Such benefits include being able to access the content now readily available on the Internet in addition to the ability to access a multitude of services available such as e.g. banking, placing stock trades, making airline reservations, and shopping etc. A further impetus arrives in the fact that adding to the attraction of providing such services is not lost on the mobile operators since significant potential revenues may be gained from the introduction of a whole host of new value-added services.

One proposed solution to allow mobile users to access the Internet is Wireless Application Protocol (WAP). WAP is an open standard for mobile clients that, although being similar in operation to the well-known Internet technology, is optimized to meet the bandwidth constraints of the wireless environment. This is achieved, among other things, by using a type of binary data transmission to optimize for long latency and low bandwidth in the form of wireless markup language (WML) and WML script. WML and WML script are optimized for use in hand-held mobile clients for producing and viewing WAP content and are analogous to the Hypertext Markup Language (HTML) and Java script used for producing and displaying content on the WWW.

FIG. 1 shows the basic architecture of a typical WAP service model which allows content to be hosted on WWW origin servers or WAP servers that are available for wireless retrieval by the client. By way of example, a WAP compliant client 100 containing a relatively simple built-in micro-browser is able to access the Internet via a WAP gateway 120 installed in a mobile phone network, for example. To access content from the WWW, a WAP client 100 may make a wireless WML request 110 to the WAP gateway 120 by specifying an uniform resource locator (URL) via transmission link 130 on an Internet origin server 140. A URL uniquely identifies a resource, e.g., a Web page or a document on an Internet server that can be retrieved by using standard HTTP over Internet Protocol (IP). The WAP gateway 120 then retrieves the content from the server 140 via transmission 150 that is preferably prepared in WML format, which is optimized for use with WAP clients. If the content is only available in HTML format, the WAP gateway 120 may attempt to translate it into WML, which is then sent on to the WAP client 100 via wireless transmission 160 in such way that it is independent of the mobile operating standard. For a more complete description of WAP architecture and the WAP environment the interested reader may refer to “Wireless Application Protocol Architecture Specification”, WAP Forum, Apr. 30, 1998. and “Wireless Application Environment Overview”, WAP-195-WAEOverview, Version Mar. 29, 2000, WAP Forum, URL: www.wapforum.org.

FIG. 2 shows the fundamental protocol stack used in the WAP architecture. The protocol stack is comprised of various hierarchical protocol layers that comprise rules that govern traffic and behavior in data transmission. The uppermost layer WAE 200 (Wireless Application Environment) represents a broad application environment depicting the functional operation of services and applications operating at the application level, as shown by reference numeral 205. Below the WAE layer 200 in the hierarchy is the WSP layer 210 (Wireless Session Protocol), which comprises session-related services connected with making browser application requests, for example. The WTP 215 (Wireless Transaction Protocol) layer is involved in operations for reliable data transmission such as interactive browsing, for example. The WTLS layer 220 (Wireless Transport Layer Security) contains optional services that are associated with the security of data transmissions and which may optionally be used by various applications.

The lowermost protocol layer in the WAP protocol stack is the WDP layer 225 (Wireless Datagram Protocol) which operates above the bearers intended for information transmission in a particular network. WDP provides a common interface to the upper protocol layers such that they are able to operate independently of the underlying network. Such networks may include those operating in accordance with the Global System for Mobile Communication (GSM), Time Division Multiple Access (TDMA), Code Division Multiple Access (CDMA), and Wideband Code Division Multiple Access (WCDMA), for example, and are depicted by reference numeral 230. Moreover, bearers of this kind may include short messages (SMS, Short Message Services), data calls (CSD, Circuit Switched Data), packet radio services such as GPRS (General Packet Radio Service), for example.

By many accounts, wireless e-commerce will be a significant contributing factor behind the proliferation of the mobile Internet. In other words, the number of users that conducting business by paying for goods with a mobile terminal is expected to grow tremendously in the coming years.

A significant issue that must be address in order to provide the favorable conditions necessary for such growth is security for electronic transactions. Widespread acceptance of e-commerce will simply not occur unless users have confidence that their transactions will be secure and safe from wrongdoers. With this in mind, a protocol to ensure secure transactions for electronic payments over an open network such as the Internet has been developed called Secure Electronic Transaction (SET). SET is an open specification for making credit card payments over the Internet which was developed primarily by the major credit card issuers Visa and Mastercard. In the SET system, each of the parties involved in the transaction uses specific software i.e. SET cardholder software by the customer and SET merchant software by the merchant. The merchant performs authorization of the payment through a connection to the acquirer's bank payment gateway that also runs SET software. The SET system provides secure transactions by utilizing a public key infrastructure to provide confidentiality and integrity of the data communication and authentication of participants.

In preparation for mobile e-commerce, there have been efforts to extend secure transaction functionality to the wireless arena. However, at this point, no standard for wireless use has emerged which has achieved widespread acceptance. Furthermore, although WAP provides a measure of security through the WTLS layer, the standard does not include a payment protocol or explicit support for one. However WTLS does provide user and client authentication similar to that of the advanced versions of Secure Sockets Layer (SSL) protocol commonly used over the Internet. WTLS can provide secure communication between the terminal and the WAP gateway. WAP defines a general application environment but does not provide a specific definition for secure transactions over the Internet between interested parties.

In view of the foregoing, a method and system is needed that provides the a secure environment for wireless payment transactions by providing a measure of authentication between transaction participants and avoiding the transmission of sensitive customer information such as credit card numbers over the Internet. A further objective is permit wireless payments with existing wireless Internet access systems such as WAP using standard Internet-enabled terminals.

### SUMMARY OF THE INVENTION

Briefly described and in accordance with an embodiment and related features of the invention, in a method aspect there is provided a method of shopping for items selected online by a mobile user from a merchant via a wireless telecommunication system, said method comprising the steps of:

establishing a wireless connection with a gateway server by said mobile user;

browsing said merchants for items of said goods and services;

selecting said items the user intends for purchase from said associated merchant;

initiating a transaction for payment by said merchant for said selected items to a trusted financial entity capable of making payment on behalf of said mobile user, wherein said payment transaction occurs without the transmission of sensitive user financial data outside the financial entity; and

relaying the results of the transaction to the mobile user via the wireless connection.

In a system aspect there is provided a system for making payments by a user with a wireless terminal for items selected from a merchant, said system comprising:

a gateway server in wireless communication with said wireless terminal for providing the user access to said merchant via an HTTP connection;

an entity having stored financial information of the mobile user is securely connected to said gateway server and connected to said merchant via a secure transmission protocol; and

means for authenticating the user to the entity to provide payment to the merchant from the financial information.

In a further method aspect there is provided a method of conducting payment for goods and services from a merchant with a wireless terminal using a payment system, wherein the system is characterized in that a gateway server is in communication with the wireless terminal and the merchant such that a query message from the merchant for payment is received by the gateway and sent to a Server Wallet entity that effects payment to the merchant, the method comprising the steps of:

establishing a secure connection between the wireless terminal and the gateway server;

sending the query message from the merchant which is received by the gateway;

forwarding the query message from the gateway to the Server Wallet entity;

authenticating a user of the wireless terminal to the Server Wallet entity by using authentication details originating from the user;

executing payment from the Server Wallet entity to the merchant; and

confirming the payment to the user.

### BRIEF DESCRIPTION OF THE DRAWINGS

The invention, together with further objectives and advantages thereof, may best be understood by reference to the following description taken in conjunction with the accompanying drawings in which:

FIG. 1 is an illustration of a basic WAP service model;

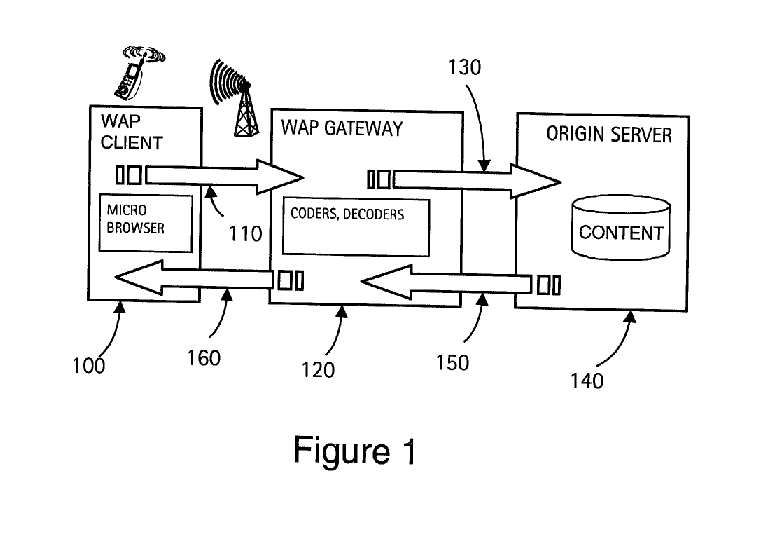

FIG. 2 shows the fundamental protocol stack used in the WAP system;

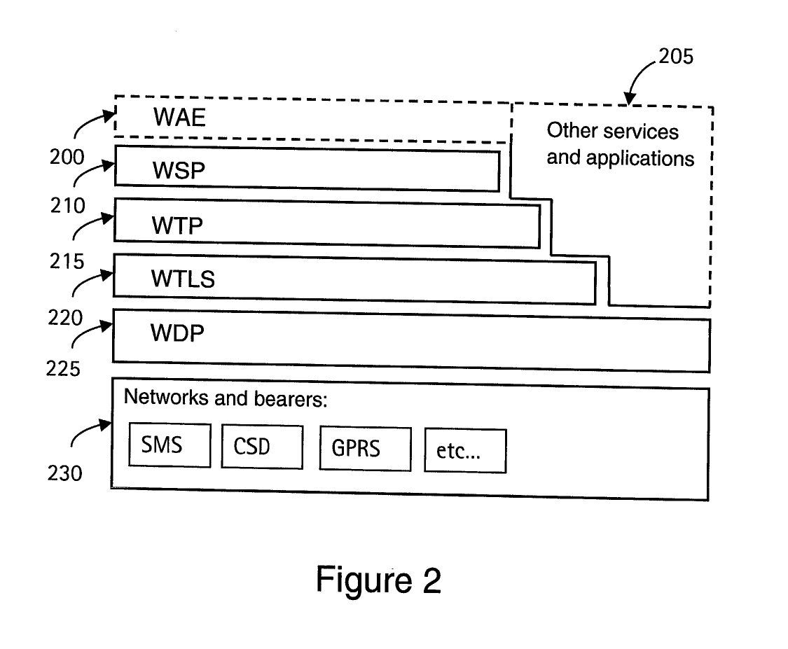

FIG. 3 shows the basic architecture of secure payment system for wireless terminals operating in accordance with an embodiment of the present invention;

FIG. 4 illustrates the operating relationship between components in WET architecture;

FIG. 5 illustrates the phases involved in the making a purchase in accordance with an embodiment of the present invention;

FIG. 6a shows the message sequence between the components in a first embodiment of the present invention;

FIG. 6b shows a second embodiment of the invention using WTLS class 3 security with support for WIM digital signatures;

FIG. 6c shows a third embodiment of the invention using WTLS class 2 security with no support for WIM and digital signatures; and

FIG. 7 shows the signaling between the WET system and an exemplary Verifier module.

### DETAILED DESCRIPTION OF THE INVENTION

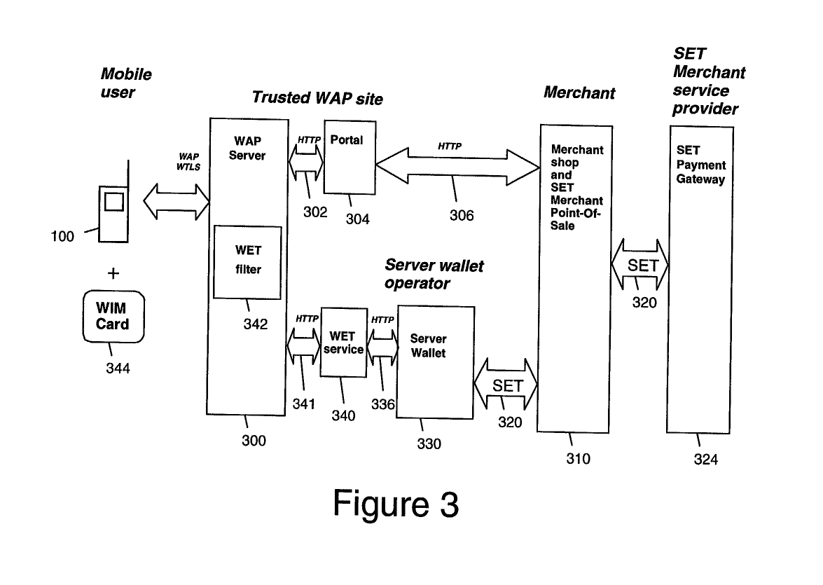

FIG. 3 shows a functional block diagram of a payment system for wireless terminals operating in accordance with an embodiment of the present invention. A mobile terminal 100 establishes a secure session with a trusted WAP Server 300 using standard WAP security layer protocols. With a session established, the mobile user is able to browse goods and services available from a variety of merchant shops, for example. In the embodiment, the user is able to find and link to a desired merchant shop 310 through a WAP portal 304 via an HTTP Internet connection 302 from the WAP server 300. A portal page is typically a welcome page that provides links to the available merchants from one convenient location. Portal 304 provides an HTTP link 306 to the various merchant shops offering a collection of goods and services of which the customer is able to browse. In addition to traditional items, these goods and services may include digital content such as music, movies, electronic books, games, video clips, or other kind of entertainment content which may be used directly in the user's terminal or transferred to an appropriate terminal for use. It should be noted that the use of portal 304 is an optional since many merchants Web pages that are accessible by typing in the address of the merchant directly in the browser, for example. While browsing, the user is able to select various items from the merchant via HTTP connection 306 before progressing to the state where he is ready to pay.

Once the merchant 310 receives an indication that the customer is ready to perform a payment transaction, the user is subject to identification if not already done so. Identification and authentication of the user's identity can be done in a number of ways such as using passwords, biometrics e.g. fingerprints, retinal scans etc., or verifying digital signature made by the user. Typically, the user would be authenticated when the secure WAP connection (WTLS class 3) is created with a WAP Identity Module (WIM). WIM would support the use of digital signatures as well. The type of authentication performed can vary according to the abilities of the terminal and it can also be determined in advance by the system designer. The moment at which the authentication is made can also vary upon whether the secure connection (WTLS) is formed with client authentication or whether the authentication is performed at a separate later stage for the purpose of the transaction, e.g., by validating the digital signature made by the user.

Before the payment is performed, the user will be asked to confirm the payment. One way to do this is to ask the user to sign the payment receipt digitally. This would provide proof of confirmation of the payment for non-repudiation purposes. This is possible when wireless terminal 100 supports the use of digital signatures that are generated in the terminal. Digital signatures generated by the terminal will be able to provide authentication of the customer even if a WTLS class 3 connection with user authentication is not available. This type of user authentication is performed for Wireless Electronic Transactions (WET) service 340 which can then authenticate the user to payment entity such as a Server Wallet. Alternatively, the confirmation can consist of an additional question asked of user as it is done in some applications used on the Web.

In a payment procedure, the merchant shop 310, running SET Merchant point-of-sale (POS) software, handles the SET protocol initiation and discussion after the user has selected items and indicates the desire to pay for the goods. The SET merchant software is the standard SET software handling the merchant part for conducting transactions based on the established SET protocol 320. When user indicates the desire to pay to the merchant 310, the SET merchant POS 310 creates a SET payment wakeup message that is sent back to user. The SET wakeup message is an initiation message from the merchant to the customer which is used to initiate the payment protocol. On its way, the wakeup message is intercepted by a WET filter 342 in WAP server 300 and sent to WET service 340 via HTTP connection 341. The WET service 340 then sends the wakeup message to a Server Wallet 330 to process the payment. The WET service 340 acts as a gateway in the discussion between terminal 100 and the Server Wallet 330. For example, when WTLS class 3 and digital signatures is supported and operating together with the WIM 344 in terminal 100, the WET service 340 opens the user's “wallet” on the Server Wallet 330 based on a previously performed authentication. The user is able to receive an electronic invoice for the purchase. The WET service 340 sends a modified electronic invoice for transmission through the WAP system and requests a confirmation from the user for the payment. In the request sent to terminal 100, the user can select the account to be used for the payment and is asked to digitally sign the electronic invoice to confirm the payment. When agreed, the generated signature is sent back to WET service 340 which verifies the signature. When the signature is verified, the payment is confirmed to the Server Wallet 330 by WET service 340.

After the payment has been confirmed, the Server Wallet 330 conducts a SET payment transaction discussion with the SET Merchant 310 via connection 320. The SET Payment Gateway 324 provides the payment card issuer's authorization for a payment to the SET merchant 310. The SET Payment Gateway 324 receives the customer's confidential financial information that is typically protected by a dual signature from merchant and contacts issuer for payment authorization. The ongoing SET communications are transparent to the customer while providing the high level of security required for electronic financial transactions.

A Server Wallet, as implemented in the present invention, stores a customer's electronic version of a “wallet” which contains payment means such as credit card details, certificates and private keys that facilitate secure online payments without having to transmit actual credit card numbers over the wireless network or the Internet.

It is recommended that the SET Server Wallet 330 is maintained by an entity that is trusted by the customer, e.g., a financial institution such as a bank, a trusted operator, or card issuers (typically banks) since it will possess sensitive financial information of the users. An advantage of a server based “wallet” is that it eliminates the necessity for the additional software to be hosted on the client terminals. This adds a layer of transparency to the transaction and furthers the convenience of online purchasing to the user.

In creating a new customer wallet, the information about the cardholder is kept on a server i.e. a Server Wallet server external to the cardholder's host (mobile terminal). The Server Wallet allows cardholders to register to the service after which they can add one or more payment cards to their “wallet” that are available for providing online payments. The information in the server wallet is typically kept in a tamper-resistant security module using hardware cryptographic devices. The SET private keys of the cardholder are generated in the module and are encrypted under the module's internal key-encryption key when exported outside. The security module provides a high level of confidence that cardholder's private keys will not be compromised and that they cannot be used except within the security module they were created in. The present invention utilizes a Server Wallet provided by Globeset Corp. of Austin, Tex. URL: www.globeset.com.

To maintain integrity of the system, all communication between the Server Wallet 330 and the WAP Server 300 must be secure. This can be accomplished by, e.g., using SSL or sending all communications through a virtual private network (VPN) using IP tunneling. An IP tunnel provides additional security by encapsulating IP packets to conceal the final destination of the packet, in addition to encrypting the payload data. Thus all HTTP requests from the WAP server 300 to Server Wallet 330 take place over the secure connection 336. The security for wireless communications between the terminal 100 and WAP Server 300 is provided through the WTSL WAP security layer as mentioned earlier. Furthermore, a Wireless Identity Module (WIM) 344 can be inserted in the terminal to enhanced security for user identification and authentication in WAP based systems. The WIM is a small tamper resistant device that can be implemented on a smart card (e.g. a GSM SIM) that is used to protect secure sessions by performing cryptographic operations and securely storing, typically certified, private keys. A more complete description of WIM can be found by referring to “Wireless Application Protocol Identity Module Specification, Part: Security”, WAP Forum, Version Nov. 5, 1999.

In the embodiment of the invention, the WET Service server 340 may reside in the WAP server 300. The WET server 340 can utilize optional WAP security tools such as digital signatures and client authentication to provide authentication to the Server Wallet and a non-repudiation log. The WET server 340 is also adapted to enable communication between the WAP Server 300 and the Server Wallet 330 by converting to a format that is understood by the other. This allows the WAP-based terminal 100 and WAP Server 300 to successfully communicate with the Server Wallet 330. This may include filtering or modifying relevant information from the messages passed between the Server Wallet and the WAP Server. As mentioned earlier, a significant role of the WET filter 342 is to intercept the SET initiation wakeup messages from the merchant and reroute them to the Server Wallet 330 via WET Server 340.

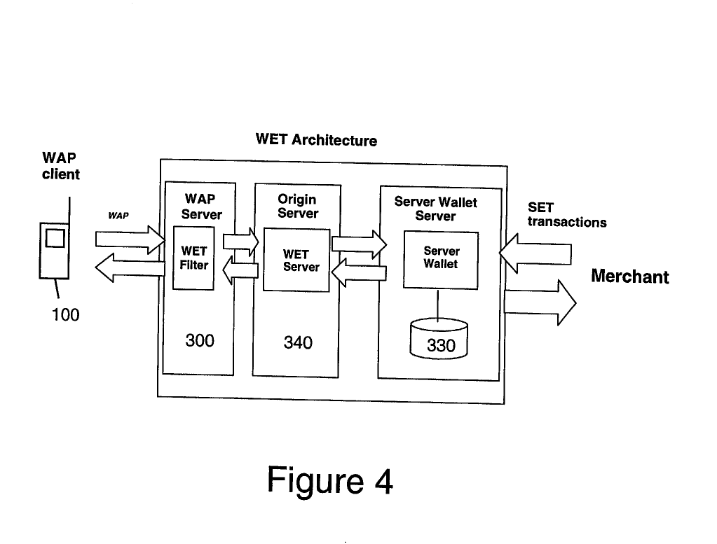

FIG. 4 illustrates the functional relationship between the components in WET architecture. The figure shows the communication pathways between the WAP Server 300, WET Server 340 (shown hosted on an separate origin server), and Server Wallet 330. The communication between these servers must happen within a trusted domain. Thus it is recommended that the Server Wallet operator maintain all the servers in order to provide comprehensive electronic wallet service to their customers or, alternatively, each party maintaining the servers is trusted and that the communication between the servers occurs over secure connections. It is important that all components interfacing with WET system maintain correspondingly similar levels of security, e.g., the WAP Security Layer ensures security in communications between the WAP Server 300 and WAP terminal 100 and communications with the Server Wallet are secure using the SET protocol.

The WET architecture must have the ability to identify the mobile user with the confidence that is at least equal to that of SET system itself. The present invention is flexible in that it allows for the option of performing authentication based on passwords to open the “wallet”. However, additional security can be obtained by using supplemental authentication measures such as a security token that requires an authentication PIN code so that the user must have the proper device operating in conjunction with a PIN. Identification of the user and authentication to the server can be done using WIM authentication or by using digital signatures generated with WIM. For confirmation, user can be asked to digitally sign the payment receipt to provide proof of the issued confirmation on the WET service.

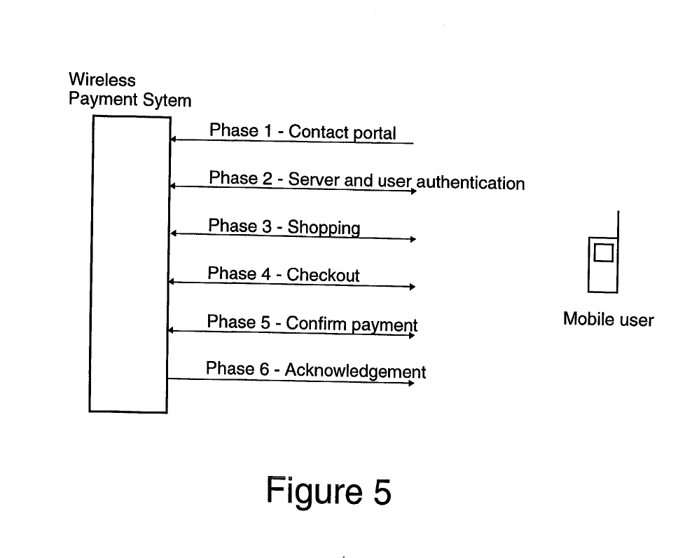

FIG. 5 illustrates the phases involved in an exemplary purchasing process using the payment system for wireless terminals described in the present invention. In phase 1, the mobile user contacts a portal that hosts a list of merchants and associated products and services on offer using standard WAP procedures. As noted earlier, the connection to the portal instead to the shop directly is optional but often provides a convenient place to for users to start. In phase 2, the connection can be secured with WTLS to provide confidentiality and integrity. It is possible to use WTLS class 2 security in which case the WAP server is authenticated to the customer, or alternatively, WTLS class 3 security where the customer is authenticated to the WAP server. If only server authentication is performed, the user authentication must be performed later by other means (e.g., via digital signature or username and password). Once a secure connection is established, the user can shop by browsing the merchants available through the portal, as shown in phase 3. While shopping the user can select items he wishes to purchase and progresses to the state where he is ready to pay.

In the checkout phase 4, the user is shown an itemized price list of his selected items and the total amount. At this point, the user may be asked for delivery details and other purchase details such as the selection of the payment method he wishes to use for the purchase, all of which, is sent back to the merchant. The checkout phase is carried out by the merchant and the actual payment procedure then starts. In the payment confirmation step of phase 5, the user receives an electronic invoice and is asked to select which payment card to use from those available from the user's server “wallet”.

The user is asked to confirm the payment by sending a digital signature. By way of example, the terminal software controls the user interface to display text containing the invoice and asks whether user wants to sign it (Yes/No). Users may scroll down if all of the text does not fit in the display at once. Answering ‘No’ means that user will be returned to the previous step and answering ‘Yes’ proceeds with the signing process. Terminal then asks user for a signature PIN. If this PIN is entered correctly, the signature is created and sent to WET service. It should be noted that the user interface could be adapted to confirm purchases without using digital signatures, in which case, the display shows a text that contains payment information together with the payment method information and the optional short description of the order. User can answer ‘no’ or ‘yes’ thereafter the answer is sent to WET server. Additional information or questions may be added as in the usual WAP service.

After the confirmation the payment procedure is started on the Server Wallet. A Server Wallet supporting the SET protocol enables debit and credit card payments to be performed with the wallet. The invention can be adapted for use with a “wallet” server or “purse” server supporting a payment protocol other than SET. The invention only requires that the Server Wallet operates as described earlier. The financial information is stored on the Server Wallet or similar entity where it specifically it assumes that:

1) There is a way to initiate the payment using a wake-up message with a specially defined MIME type or some other easily distinguishable way; and

2) the wallet on the server requires user authentication and confirmation at some point of the execution of the payment transaction.

In the acknowledgment phase 6, an acknowledgment message informs the user on whether the payment was successfully completed. If the payment was successful, the acknowledgement message could also contain link to the merchant's success page and a link to the trusted WAP portal main page. The user can also be sent a storable receipt to the terminal, for example, via SMS. If the payment did not succeed, a response is sent to the terminal containing an error message and a link to merchant error page containing more detailed information from the merchant. In any case, the receipt from the transaction is stored to the user's “wallet” on the Server Wallet. To view past transactions, it is possible to browse receipts by opening the wallet to see the recently made payment transactions.

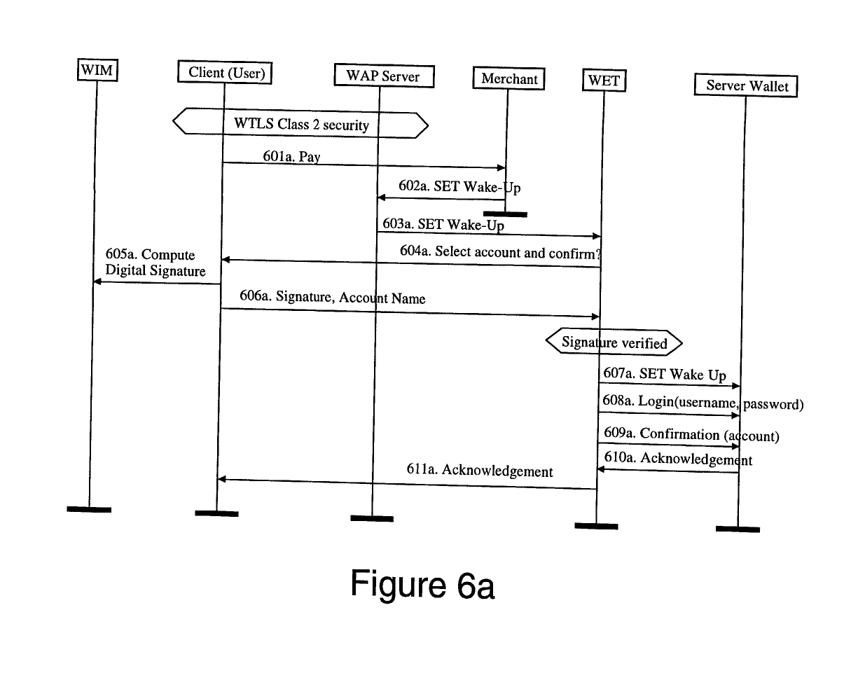

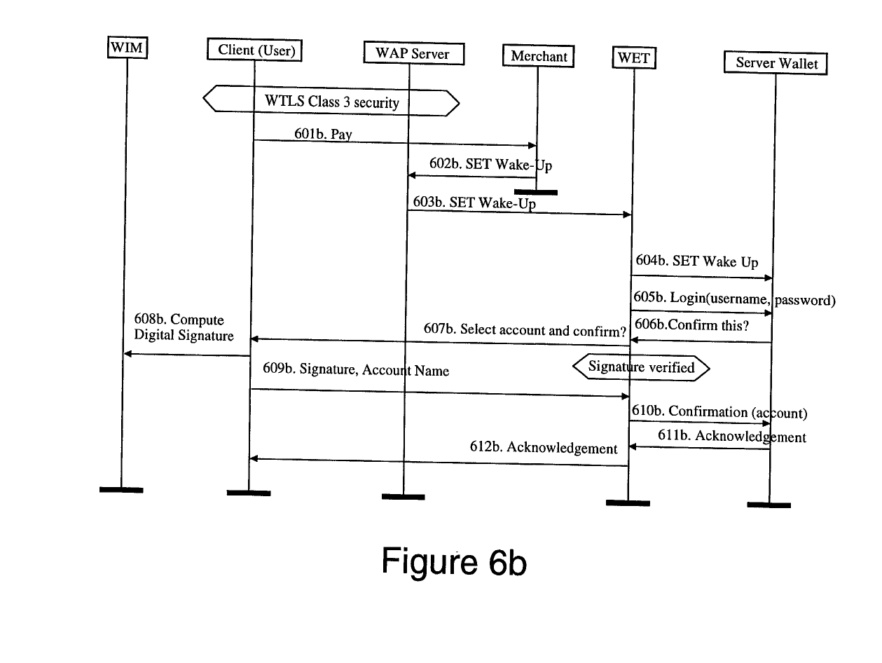

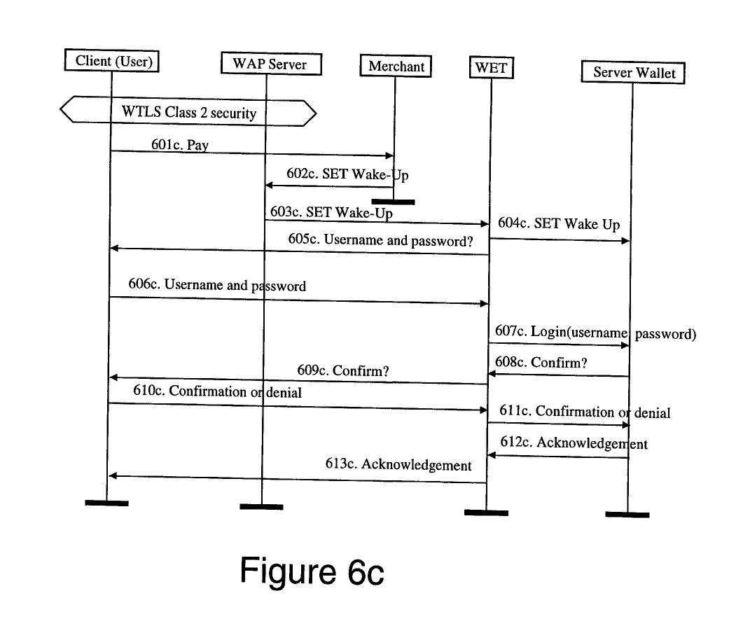

FIG. 6a shows the message sequence between the components in the payment system for wireless terminals operating in accordance with a first embodiment of the present invention. The procedure starts when a user connects to a trusted WAP site (server/gateway) using WTLS Class 2 security.

Once authenticated, the user can access the portal containing a plurality of Merchants and their corresponding listing of various products and services. The user then selects a Merchant and browses around the shop and selects items that he wishes to purchase which are collected in a selection basket. The user can also make selections from other Merchants during the browsing phase as well. When the user is ready to pay, he proceeds to the checkout phase and decides on a payment method, as shown by message 601a. The Merchant then sends a wakeup message which is detected by the WET filter in the WAP server, as shown by message 602a.

The wakeup message is rerouted to WET service, as shown by message 603a, wherein the WET service handles all discussion with Server Wallet. The WET gateway then sends a request for confirmation to the user in message 604a where the computation of a digital signature takes place using the WIM based platform, for example. It should be noted that other techniques for user verification may be employed such as using passwords, security card/readers, or biometric based user authentication such as finger prints, retinal scans etc. Confirmation request includes invoice information such as the total amount, currency etc. where the user can select the method of payment or which card account will be used for the payment. A WMLScript cryptographic library function asks the terminal with WIM to compute the digital signature for the invoice, as shown by message 605a.

The signature, together with a certificate, is then sent from the client to WET gateway in message 606a where the signature is verified and the certificate is validated. At this point the user is authenticated to WET system and authorization for the payment has been confirmed. The WET then initiates the payment transaction with Server Wallet by forwarding the SET wakeup message, as shown by message 607a. The user is authenticated to the Server Wallet in message 608a, e.g., by providing a username and password to log into the user's Server Wallet account. As the user is authenticated to the trusted WET service, the WET service may have the means to open the user's “wallet” on the Server Wallet such as the usemarnme and password of the user. Ideally, the authentication mechanism used to authenticate to the WET service could also be used to authenticate to the Server Wallet. In message 609a, a confirmation is sent from the WET to the Server Wallet in order to start the actual SET payment transaction. The Server Wallet then processes the payment transaction by charging the selected card account. The Server Wallet via the WET gateway notifies the user of the result of the transaction in message 610a and 611a.

It should be noted that the signaling sequence outlined above is exemplary and that a somewhat altered procedure is possible.

FIG. 6b shows a second embodiment of the invention using WTLS class 3 security with support for WIM digital signatures. The user is authenticated as the secure connection is created to the WAP Server. Accordingly, the WAP server may support authentication to the original server (WET) which can then authenticate the user to the Server Wallet 605b bright after sending the wake-up message 604b. In this case, the WET service forwards the wakeup message to the Server Wallet then, anytime after, the user can be authenticated to the Server Wallet. This allows more flexible use of Server Wallet via the WET service.

FIG. 6c shows a third embodiment of the invention using WTLS class 2 security with no support for WIM and digital signatures. Examples of WAP compliant products that are applicable for use with the invention include the Nokia WAP Server and the Nokia 7110 and 9110i mobile terminals, for example. The WAP compliant server is authenticated using WTLS class 2 server authentication procedures. In this case the user will be asked for password or similar for authentication 605c and the received information can be used directly to authenticate the user to the Server Wallet as well in messages 606c and 607c. In response, the Server Wallet sends the request for confirmation 608c which is forwarded to the user 609c. The answer is sent to the Server Wallet via the WET in messages 610c and 611c where the transaction proceeds with an affirmative answer (otherwise cancelled when denied). The Server Wallet returns an acknowledgement 612c containing the result to the user 613c via the WET.

The use of digital signatures requires that the signature is verified on the server side. In the described embodiment, server side verification by the WET gateway requires access to facilities in order to validate the signature and the validity of the user certificate. This can be accomplished by using a separate or embedded validator. The validator module or server can be a general module for use with the WAP Server or with the Origin Server to verify the signatures.

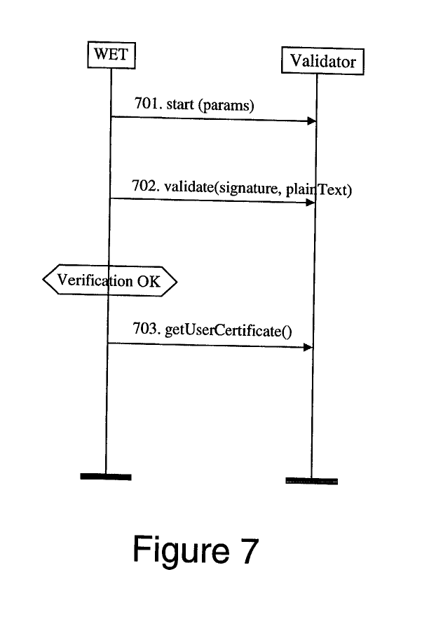

FIG. 7 illustrates the signaling between the WET system and an exemplary validation module that can be used with the embodiment. The validator receives the start parameters in message 701 and a plain text digital signature in message 702 from the WET. The verification of the signature and certificate can be performed. Message 703 shows by the way of example that the user certificate can be requested for further examination by the WET. A number of standard validation modules are available on the market that can be used with the system. By way of example, suitable products are provided by Baltimore Telepathy PKI Validation System by Baltimore Technologies Ltd., Ireland, URL: www.baltimoretechnologies.com, and SmartTrust Servant product by SmartTrust Corp., URL: www.SmartTrust.com.

The present invention contemplates a secure payment system for wireless terminals that is compatible with existing wireless Internet access systems such as WAP. An advantage of the invention is that the SET communication messages, e.g. the SET wakeup message, interacts only with the WET mechanism thereby allowing the use of standard WAP terminals via the WAP Server. Although the invention has been described in some respects with reference to a specified embodiment thereof, variations and modifications will become apparent to those skilled in the art. In particular, the various omissions and substitutions of elements and/or signaling steps may be performed without departing from the inventive concept as described by the invention. For example, it is expressly intended that the arrived combinations which perform substantially the same function in substantially the same way which achieve substantially the same results are within the scope of the invention. It is therefore the intention that the following claims not be given a restrictive interpretation but should be viewed to encompass variations and modifications that are derived from the inventive subject matter disclosed.

1. A method of shopping for items selected online by a mobile user from a merchant via a wireless telecommunication system, said method comprising the steps of:
establishing a wireless connection with a gateway server by said mobile user;
browsing said merchants for items of said goods and services;
selecting said items the user intends for purchase from said associated merchant;
initiating a transaction for payment by said merchant for said selected items to a trusted financial entity capable of making payment on behalf of said mobile user, wherein said payment transaction occurs without the transmission of sensitive user financial data outside the financial entity; and
relaying the results of the transaction to the mobile user via the wireless connection.

2. A method according to claim 1 wherein said gateway server is a WAP Server operating in accordance with Wireless Application Protocol (WAP), and wherein said WAP Server is in wireless communication with said mobile user using standard WAP procedures.

3. A method according to claim 2 wherein said browsing occurs through a WAP portal page arranged to present said plurality of available merchants and provide selectable links to said merchants and their goods and services.

4. A method according to claim 1 wherein said trusted financial entity is a Server Wallet server performing a service capable of conducting online payments on behalf of the mobile user.

5. A method according to claim 4 wherein the Server Wallet contains payment card numbers associated with the mobile user.

6. A method according to claim 1 wherein the payment transaction between the merchant and the financial entity occurs in accordance with the Secure Electronic Transaction (SET) protocol standard.

7. A method according to claim 4 wherein the initiating a transaction for payment step includes sending a wakeup message intended for the user by the merchant, and wherein the message is instead received by the gateway server and forwarded to the Server Wallet.

8. A method according to claim 2 wherein a Wireless Identity Module (WIM) is used together with the wireless terminal to calculate a digital signature for confirming the transaction payment.

9. A method according to claim 1 wherein said goods and services purchased may include digital content such as music, movies, electronic books, games, video clips, or other kind of entertainment content which may be used in the user's terminal or transferred to an appropriate terminal for use.

10. A system for making payments by a user with a wireless terminal for items selected from a merchant, said system comprising:
a gateway server in wireless communication with said wireless terminal for providing the user access to said merchant via an HTTP connection;
an entity having stored financial information of the mobile user is securely connected to said gateway server and connected to said merchant via a secure transmission protocol; and
means for authenticating the user to the entity to provide payment to the merchant from the financial information.

11. A system according to claim 10 wherein the gateway server is a Wireless Application Protocol (WAP) Server.

12. A system according to claim 11 wherein the entity is a Server Wallet.

13. A system according to claim 12 wherein the secure transmission protocol between the merchant and the Server Wallet is Secure Electronic Transaction (SET) protocol.

14. A system according to claim 13 wherein a SET payment gateway operating on behalf of the merchant is connected to the Server Wallet.

15. A system according to claim 11 wherein said means for authenticating the user includes a digital signature calculated by an Wireless Identity Module (WIM) hosted in the wireless terminal.

16. A system according to claim 14 wherein the WAP Server further comprises a component for intercepting a wakeup message sent from the merchant and for forwarding the wakeup message to the Server Wallet.

17. A system according to claim 11 wherein a WAP portal is used to provide a link to the merchant via an HTTP connection.

18. A method of conducting payment for goods and services from a merchant with a wireless terminal using a payment system, wherein the system is characterized in that a gateway server is in communication with the wireless terminal and the merchant such that a query message from the merchant for payment is received by the gateway and sent to a Server Wallet entity that effects payment to the merchant, the method comprising the steps of:
establishing a secure connection between the wireless terminal and the gateway server;
sending the query message from the merchant which is received by the gateway;
forwarding the query message from the gateway to the Server Wallet entity;
authenticating a user of the wireless terminal to the Server Wallet entity by using authentication details originating from the user;
executing payment from the Server Wallet entity to the merchant; and
confirming the payment to the user.

19. A method according to claim 18 wherein the gateway server is a WAP server operating in accordance with Wireless Application Protocol (WAP).

20. A method according to claim 18 wherein the authentication details used to authenticate the user to the Server Wallet entity includes the use of a digital signature.

21. A method according to claim 20 wherein a Wireless Identity Module (WIM) operating together with the wireless terminal is used to compute a digital signature for authenticating the user to the Server Wallet.

22. A method according to claim 20 wherein the authentication details further include the use of passwords, fingerprints, and retinal scans.

23. A method according to claim 19 wherein the query message is a wakeup message received by the WAP server from the merchant and forwarded to the Server Wallet entity, and wherein the transaction involving the executed payment is sent to the merchant in accordance with the Secure Electronic Transaction (SET) protocol.
